(19) United States
(12) Patent Application Publication
(10) Pub. No.: US 2024/0221481 A1
(43) Pub. Date: Jul. 4, 2024

(54) A VISIBILITY-IMPAIRING SECURITY DEVICE

(71) Applicant: Essence Security International (E.S.I.) Ltd., Herzlia Pituach (IL)

(72) Inventors: Pavel LINDBERG, Rosh HaAyin (IL); Eran VENDRIGER, Tel-Aviv (IL); Eran COHEN, Tel-Aviv (IL)

(21) Appl. No.: 18/563,283

(22) PCT Filed: May 24, 2022
(86) PCT No.: PCT/IL2022/050544

§ 371 Date: Nov. 21, 2023

(30) Foreign Application Priority Data
May 25, 2021 (IL) 283436

(51) Int. Cl. G08B 15/02

(52) U.S. Cl. CPC G08B 15/02

(57) ABSTRACT

A visibility-impairing security device is disclosed for producing a gathering of air¬ suspended light-obscuring matter to obscure vision. The device comprises an insertable battery holder for holding at least one battery and a body comprising: a battery-holder receiving portion for receiving therein the battery holder; an emission unit receiving portion for holding an emission unit for emitting the matter in response to a delivery of energy derived from the at least one battery; and an interference member held by the body and movable between (i) a blocking position that blocks receipt of the battery holder into the battery-holder receiving portion and (ii) a withdrawn position whereby the battery holder is insertable into the battery-holder receiving portion. When the emission unit is held in the emission unit receiving portion the interference member is in the blocking position.

### RELATED APPLICATION

This application claims the benefit of priority of Israel Patent Application No. 283436 filed on 25 May 2021, the contents of which are incorporated herein by reference in their entirety.

### FIELD OF DISCLOSURE

The disclosure relates to a visibility-impairing security device. Particularly, but not exclusively, the device may be configured to emit smoke or fog after detection of an intruder.

### BACKGROUND

Visibility-impairing security devices may be used to produce a gathering of air-suspended light-obscuring matter, e.g. a composition of water vapor or smoke, in order to make it difficult for an intruder to see their environment.

The matter may be emitted from an emission unit held by the device, when power is supplied to the emission unit. The provision of power to electrical terminals of the emission unit, e.g. in the form of a voltage pulse, may trigger a reaction (e.g. an exothermic reaction) in the emission unit, resulting in production and release of the matter. Furthermore, the reaction may be unstoppable once started.

Safety mechanisms may be employed to ensure that the electrical terminals are not accidentally applied with such power. For example, a circuit that delivers power to the electrical terminals may be designed to only hold zero voltage across the electrical terminals unless a matter release command is provided by a microprocessor in the device. However, when connecting power to the device electronics, transient uncontrolled states may exist before a steady and stable device-powered state is reached. During such transient states there is potential for an unintended transient voltage to be presented to the emission unit's terminals, thereby causing unintended emission of matter.

### SUMMARY

One or more aspects of the present disclosure relate to visibility-impairing security devices configured to output smoke or fog or the like, for example, as a deterrent after detection of a security related event (e.g. sensing an intruder's motion) and wherein a possibility of unintended emission of matter is ameliorated.

In accordance with a first aspect of the disclosure there is provided a visibility-impairing security device for producing a gathering of air-suspended light-obscuring matter to obscure vision, the device comprising:
an insertable battery holder for holding at least one battery: and
a body comprising:
   a battery-holder receiving portion for receiving therein the battery holder; and
   an emission unit receiving portion for holding an emission unit for emitting the matter in response to a delivery of energy derived from the at least one battery; and
   an interference member held by the body and movable between (i) a blocking position that blocks receipt of the battery holder into the battery-holder receiving portion and (ii) a withdrawn position whereby the battery holder is insertable into the battery-holder receiving portion;
wherein when the emission unit is held in the emission unit receiving portion the interference member is in the blocking position.

Embodiments of the first aspect of the disclosure therefore relate to security devices in which light-obscuring matter may be output as a deterrent to ward off an intruder and wherein unintended emission of such matter is ameliorated because the batteries must always be installed in the device prior to installation of the emission unit (as otherwise the insertion of the batteries is blocked). This feature ensures that the emission unit is only present when there is likely to be a stable electrical connection between the batteries and the device circuitry. More specifically, the configuration of the device requires that the batteries be loaded before the emission unit. This reduces the risk of transient electrical states triggering an unintended emission of matter.

In some embodiments, the batteries may not be removed from the device before removal of the emission unit as the presence of the emission unit may also cause the interference member to block the removal of the battery holder from the battery-holder receiving portion.

The device may comprise an insertable emission unit comprising at least an emission unit housing and when the emission unit housing is held in the emission unit receiving portion the interference member is in the blocking position.

The receipt of the battery holder into the battery-holder receiving portion may form an electrical path. This may occur when the battery holder is fully inserted in the battery holder receiving portion.

Breaking the electrical path by relative movement of the battery holder with respect to the body may require the interference member to be moved out of the blocking position, e.g. to said withdrawn position.

When the emission unit is held in the emission unit receiving portion, the emission unit may block the interference member from being in the withdrawn position.

The holding of the emission unit in the emission unit receiving portion may comprise the emission unit being in a position in which the emission unit has an electrical connection for receiving the delivery of energy.

The absence of the emission unit from the emission unit receiving portion may enable the interference member to be in the withdrawn position.

When the emission unit is absent from the emission unit receiving portion, the interference member may be moved into the withdrawn position by inserting the battery holder into the battery holder receiving portion towards a position in which an electrical path exists between the at least one battery and control circuitry in the body for controlling the delivery of energy.

When the battery holder is in said position in which an electrical path exists between the at least one battery and control circuitry in the body for controlling the delivery of energy, the interference member may be returned by a biasing force to the blocking position to block removal of the battery holder from the battery holder receiving portion.

When the emission unit is absent from the emission unit receiving portion, the interference member may be moved into the withdrawn position by pressing an actuator.

The actuator and the interference member may be on opposite ends of a component that rocks about a pivot axis (e.g. by means of a hinged connection) within the body and intermediate the opposite ends.

The actuator may be integrally-formed with the interference member, i.e. they may formed as one part.

The actuator may be inaccessible when the emission unit is held in the emission unit receiving portion.

The interference member may be biased towards the blocking position.

The interference member may be biased towards the blocking position by a spring.

The spring may be integrally-formed with the interference member, i.e. they may formed as one part.

The entry and/or removal of the emission unit and the battery holder may be in parallel directions.

The emission unit receiving portion and the battery holder receiving portion may be adjacent to each other and the emission unit receiving portion and the battery holder receiving portion may each open at adjacent locations to a common side of the body. This allows for an unobstructed path for emission of the light-obscuring matter from the emission unit and also provides easy access to replace the battery/batteries while the device is mounted on a wall. Furthermore, by having a removable battery holder, the battery/batteries may be readily replaced with minimal fiddling. Similarly, the replacement of a canister in the emission unit is easily facilitated.

The common side may be a bottom side of the device.

The emission unit may have an outlet for emitting the matter and the outlet may be positioned, when the emission unit is held in the emission unit receiving portion, toward a bottom of the device to emit the matter from a bottom side of the device.

The device may further comprise a lens component, which may be a lens of a motion detector or camera. The lens component may be located at a front side of the device intended to face away from a wall when a rear of the device is mounted facing a wall.

The lens component may provide a sensor (e.g. at least one pyroelectric sensor of a PIR motion detector or an image sensor) with a field of view comprising a field of view that is symmetric about an axis intended to be vertical when the device is mounted against a wall. For embodiments in which a PIR has a plurality of pyroelectric sensor, the symmetry of the field of view may be with respect to the plurality of pyroelectric sensors as a whole, rather than for each pyroelectric sensor individually.

The field of view may span more towards a bottom end of the body than a top end of the body so as be directed more towards a floor than a ceiling when installed in a room.

The battery holder receiving portion and one or more electronic sensors may be provided in front of the emission unit receiving portion. The one or more electronic sensors may comprise an image sensor (for a camera) and/or at least one pyroelectric sensor (for a PIR motion sensor). Having such placement provides for efficient use of space and may also position the electronic sensors in a position in which they are relatively sheltered from heat generated by the emission unit.

The emission unit may generate the air-suspended light-obscuring matter (e.g. smoke or fog) upon delivery of the energy.

The emission unit may comprise a canister in which the air-suspended light-obscuring matter is generated.

The emission unit may comprise a housing for holding the canister.

The emission unit receiving portion may comprise an emission unit receptacle for containing the emission unit therein.

The battery holder receiving portion may comprise a battery holder receptacle for containing the battery holder therein.

The body may comprise a mechanical barrier, e.g. a wall, between the battery holder receiving portion and the emission unit receiving portion and/or between the battery holder receptacle and the emission unit receptacle.

The mechanical barrier may lie in a plane that is parallel to a longitudinal axis of the emission unit when held in the emission unit receiving portion.

The mechanical barrier may be thermally insulative (e.g. by being comprised of a plastic or thermoplastic).

In accordance with a second aspect of the disclosure there is provided a method of installing at least one battery in a visibility-impairing security device of any preceding claim, the method comprising:
placing the interference member in the withdrawn position: and
inserting the battery holder into the battery-holder receiving portion.

The method may further comprise removing the emission unit from the emission unit receiving portion prior to placing the interference member in the withdrawn position.

In some embodiments, the act of inserting the battery holder into the battery-holder receiving portion, when the emission unit is absent from the emission unit receiving portion, may serve to place the interference member in the withdrawn position, at least during said insertion. After insertion, i.e. on receipt of the battery holder in the battery-holder receiving portion, the interference member may be returned to the blocking position (either automatically. e.g. by a spring, or by manual placement).

In accordance with a third aspect of the disclosure there is provided a method of preventing installation of at least one battery in a visibility-impairing security device of any of the first aspect, the method comprising:
providing an emission unit in the emission unit receiving portion such that the interference member is in the blocking position; and
blocking. by the interference member, receipt of the battery holder in the battery-holder receiving portion.

It will be understood that the presence of the emission unit (or at least a part of it) in the emission unit receiving portion may require the interference member to be in the blocking position and/or may prevent the interference member from adopting the withdrawn position.

In accordance with a fourth aspect of the disclosure there is provided a visibility-impairing security device for producing a gathering of air-suspended light-obscuring matter to obscure vision, the device comprising:
an insertable battery holder for holding at least one battery; and
a body comprising:
   a battery holder receiving portion for receiving therein the battery holder; and
   an emission unit receiving portion for holding an emission unit for emitting the matter in response to a delivery of energy derived from the at least one battery;
      wherein:
receipt of the battery holder into the battery-holder receiving portion forms an electrical path between the at least one battery and control circuitry in the body for controlling the delivery of energy; and
when the battery holder receiving portion is in receipt of the battery holder, movement of the battery holder relative to the battery holder receiving portion to disconnect the electrical path is blocked while the emission unit is in the emission unit receiving portion.

The device may comprise an insertable emission unit comprising at least an emission unit housing (and optionally a canister configured for producing a gathering of air-suspended light-obscuring matter) and when the emission unit housing is held in the emission unit receiving portion said movement of the battery holder is blocked.

The device may further comprise an interference member held by the body and movable between (i) a blocking position that blocks receipt of the battery holder into the battery holder receiving portion and (ii) a withdrawn position whereby the battery holder is insertable into the battery-holder receiving portion, wherein said movement of the battery holder is blocked by the interference member being retained in the blocked position while the emission unit is held in the emission unit receiving portion.

The control circuitry may comprise a switch to identify when the emission unit is being withdrawn from the emission unit receiving portion.

The switch may have a first state when the emission unit is held in the emission unit receiving portion and a second state when the emission unit is partially withdrawn from the emission unit receiving portion.

The switch (e.g. a push switch) may extend into the emission unit receiving portion from an inner end of the emission unit receiving portion and the switch may be configured to change its state when pressed by a surface on an inner end of the emission unit which is opposite an outlet end of the emission unit.

The device may be configured to transmit a notification to a remote device when the switch is changed to the second state.

If the battery holder is removed from the battery holder receiving portion, the device will lose power. It is therefore advantageous to provide a warning that this may occur in advance of such power being lost. Advantageously, since it takes time for a person to be able to remove the emission unit from the emission unit receiving portion to thereby enable the withdrawal of the battery holder from the battery holder receiving portion, and even partial withdrawal from the emission unit receiving portion triggers transmission of a notification, this provides such a warning. Furthermore, the time taken for a person to remove the emission unit from the emission unit receiving portion to enable removal of the battery holder from the battery holder receiving portion may be longer than the time taken to reach said partial withdrawal, and may provide sufficient time for the device to connect to a cellular network (which may take as long as 5 seconds, for example) and transmit the notification prior to the power being lost.

In accordance with a fifth aspect of the disclosure there is provided a method of preventing removal of at least one battery in a visibility-impairing security device of the fourth aspect, the method comprising:
providing the battery holder in the battery-holder receiving portion to form an electrical path between the at least one battery and control circuitry in the body for controlling the delivery of energy; and
providing an emission unit in the emission unit receiving portion such that movement of the battery holder relative to the battery bolder receiving portion is blocked.

In accordance with a sixth aspect of the disclosure there is provided a kit for producing a gathering of air-suspended light-obscuring matter to obscure vision, the kit comprising:
a visibility-impairing security device accordingly to the first or fourth aspects; and
an emission unit for emitting the matter in response to a delivery of energy derived from the at least one battery.

The insertable battery holder may be provided preinstalled in the body of the device or separate from the body of the device.

It will be understood that the light-obscuring matter is configured to obscure at least visible light (i.e. visible light-obscuring matter). As such a person will not be able to see any objects through the light-obscuring material, or at least not well, and this will serve to disorientate and slow or stop a potential intruder in their tracks while security personnel are summoned.

The average particle size of the light-obscuring matter may be equal to or smaller than a maximum wavelength of a near-infrared range of an electromagnetic spectrum. For example, the light-obscuring matter may have a particle size of between 0.2 microns and 1 micron and an average particle size within that range. The near-infrared range is generally considered to have a maximum wavelength of 2.5 microns.

The light-obscuring matter may be output to generate fog. For example, the emission unit may be configured to emit water or water-based droplets to form fog after emission into the environment.

In some embodiments, the light-obscuring matter may comprise (or be) particulate material.

The light-obscuring matter may comprise smoke. In some embodiments, the light-obscuring material may be smoke.

The device may further comprise a detector configured to detect a security related event.

The detector may be configured to provide an indication of the security related event to the one or more processors.

The emission of the matter by the emission unit may be on receipt of a trigger from the security device, a control hub, a server or a monitoring station.

The receipt of the trigger may be in response to the security related event.

The detector may comprise at least one item selected from a group consisting of: a motion sensor, a vibration sensor, a magnetic sensor, a proximity sensor, a threshold sensor, a door sensor, a window sensor, a passive infrared sensor, a thermal camera, a video camera, an active reflected wave detector, a radar device, a sonar device and a lidar device.

A security system may comprise the device of the first or fourth aspects and at least one device selected from a group consisting of: a control hub; a server; and a monitoring station; wherein the at least one device is configured to transmit a trigger, identifying the need for outputting light-obscuring matter, to the emission unit.

The monitoring station may be configured to receive data from a detector and/or camera and to present the data to an operator via a display, such that an operator may decide whether or not to trigger the output of the light-obscuring matter.

The data received from the camera may correspond to one or more images taken in response to detection of a security related event.

These and other aspects will be apparent from the embodiments described in the following. The scope of the present disclosure is not intended to be limited by this summary nor to implementations that necessarily solve any or all of the disadvantages noted.

Any features described in relation to one aspect of the disclosure may be applied to any one or more other aspect of the disclosure.

### BRIEF DESCRIPTION OF THE SEVERAL VIEWS OF THE DRAWINGS

For a better understanding of the present disclosure and to show how embodiments may be put into effect, reference is made to the accompanying drawings in which:

FIG. 1A illustrates a front and side perspective view of a security device according to an embodiment of the disclosure;

FIG. 1B illustrates a bottom view of the security device of FIG. 1A:

FIG. 2 is a side cross-sectional view of the security device of FIGS. 1A and 1B;

FIG. 3 is an enlarged view of the bottom part of FIG. 2 with a portion of the battery holder removed and two front-most batteries removed;

FIG. 4 shows an enlarged view of the battery-holder receiving portion of FIG. 2 with a portion of the battery holder removed and a single battery removed:

FIG. 5 shows a rear perspective view of the battery holder when received in the device and with the emission unit removed;

FIG. 6A shows a bottom perspective view of the battery-holder receiving portion and emission unit receiving portion without the battery holder or emission unit, and showing an interference component there-between;

FIG. 6B shows a view similar to FIG. 6A but with the interference component removed;

FIG. 7A shows a bottom perspective view of the interference component in isolation when viewed from a first side;

FIG. 7B shows a bottom perspective view of the interference component in isolation when viewed from an opposite second side;

FIG. 8A shows an enlarged view of the bottom part of FIG. 2 with the battery holder and emission unit removed and the interference component in the blocking position;

FIG. 8B shows a view similar to FIG. 8A but with the interference component in the withdrawn position:

FIG. 9A shows a top perspective view of the emission unit in FIG. 2;

FIG. 9B shows a bottom view of the emission unit in FIG. 2;

FIG. 10A shows a top perspective view of the battery holder partially shown in FIG. 2, including six batteries;

FIG. 10B shows a side view of the battery holder partially shown in FIG. 2;

FIG. 11 is a flow chart of a method of installing at least one battery in a visibility-impairing security device according to an embodiment of the disclosure;

FIG. 12 is a flow chart of a method of preventing installation of at least one battery in a visibility-impairing security device according to an embodiment of the disclosure; and

FIG. 13 is a flow chart of a method of preventing removal of at least one battery in a visibility-impairing security device according to an embodiment of the disclosure.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

In the following embodiments, like components are labelled with like reference numerals.

As used herein, except wherein the context requires otherwise, the terms “comprises”. “includes”. “has” and grammatical variants of these terms, are not intended to be exhaustive. They are intended to allow for the possibility of further additives, components, integers or steps. Specific embodiments will now be described with reference to the drawings.

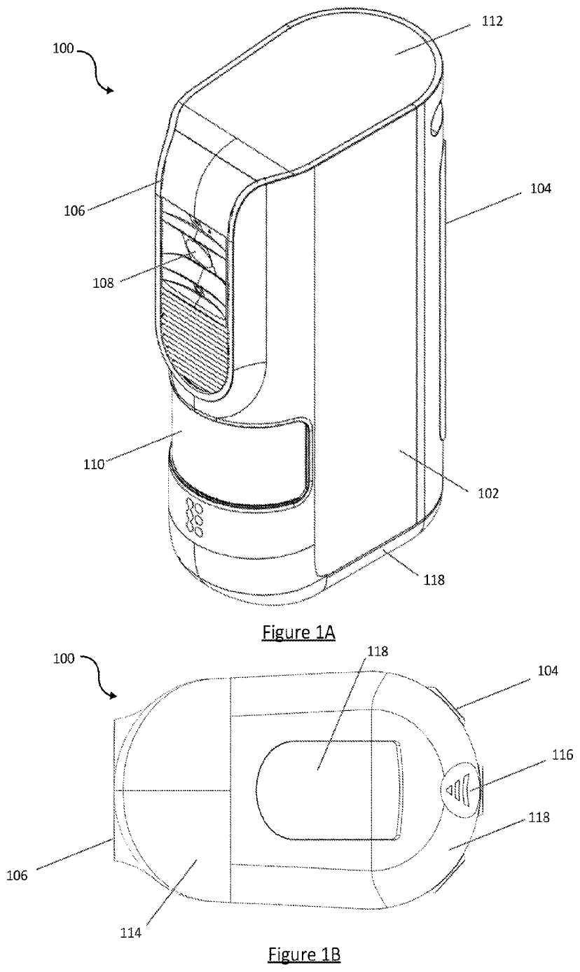

FIGS. 1A and 1B illustrate a visibility-impairing security device 100 for producing a gathering of air-suspended light-obscuring matter (not shown) to obscure vision. The device 100 comprises a body 102 having a rear surface 104 for mounting on a wall or other substantially vertical support surface and an opposite front surface 106 comprising a camera lens 108 for an imaging sensor (not shown) which captures an image of the scene, e.g. to verify a detected security-related event. The security-related event may for example be detected by a motion detector, e.g. PIR motion detector. The front surface 106 also includes a lens component 110, for the PIR detector, located at a front side of the device 100 intended to face away from a wall when the rear surface 104 of the device 100 is mounted facing a wall. The lens component 110 (e.g. a Fresnel lens sheet) may be provided in front of a further sensor (e.g. at least one pyroelectric sensor of the PIR motion detector). The image sensor and/or at least one pyroelectric sensor may be provided with a field of view comprising a field of view that is symmetric about an axis intended to be vertical when the device 100 is mounted against a wall. The field of view may span more towards a bottom end of the body 102 than a top end 112 of the body 102 so as be directed more towards a floor than a ceiling when installed in a room.

In some embodiments, only one sensor may be provided in the device 100 (e.g. instead of both an imaging sensor and a pyroelectric sensor).

As shown in FIG. 1B, the device 100 has a bottom surface 114 comprising a finger notch 116 for gripping a base portion 118 of the device 100 for removal thereof. The bottom surface 114 also comprises a door 118 configured to open to permit release of light-obscuring matter into the surrounding environment.

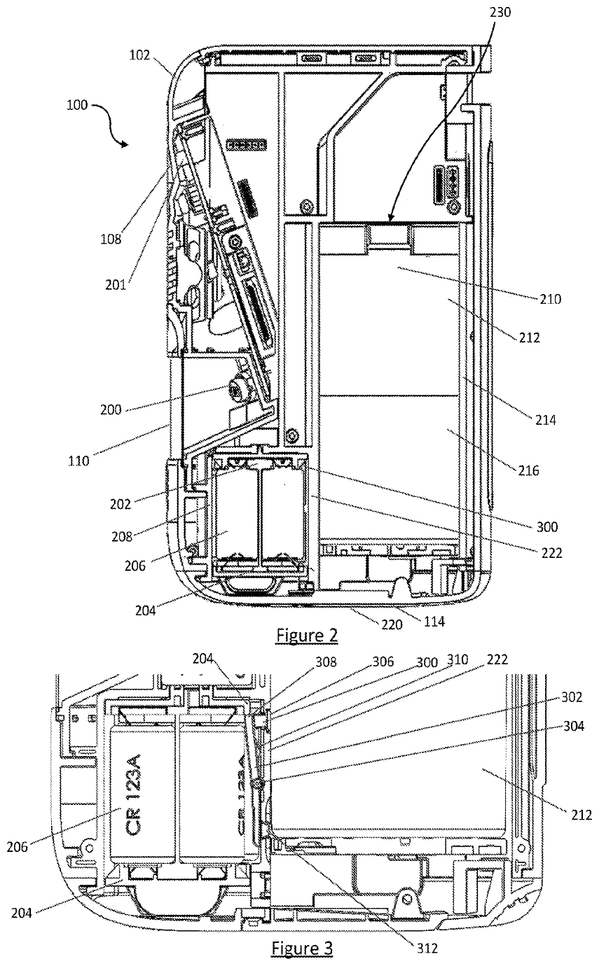

FIG. 2 is a side cross-sectional view of the security device 100 of FIGS. 1A and 1B and shows the location of a camera and other electronic components 201 behind the camera lens 108 and within the body 102. The lens component 110 is shown in front of a pyroelectric sensor 200. As shown in FIG. 2, the pyroelectric sensor 200 is angled downwardly and slightly out of the page, towards the viewer. This is because there are two pyroelectric sensors 200 in the device 100 shown and the other of the pair is located behind the pyroelectric sensor 200 shown and is angled downwardly and slightly out of the rear of the page, away from the viewer. As such, the two pyroelectric sensors 200, together, provide a symmetric field of view about a vertical centre of the device 100. Substantially below the pyroelectric sensor 200, in a front portion of the body 102 there is a battery-holder receiving portion 202 for receiving therein an insertable battery holder 204 for holding at least one battery 206. The battery holder receiving portion 202 comprises a battery holder receptacle 208 for containing the battery holder 204 therein.

The receipt of the battery holder 204 into the battery-holder receiving portion 202 (as shown) forms an electrical path between electrical terminals on a top of the battery holder 204 and circuitry in the body 102 of the device, when the battery holder 204 is fully inserted in the battery holder receiving portion 202.

The body 102 also comprises an emission unit receiving portion 210 for holding an emission unit 212 (which is shown in full as opposed to cross-section in FIG. 2) for emitting the matter in response to a delivery of energy derived from the at least one battery 206. The emission unit receiving portion 210 is provided in a rearward portion of the body 102 and comprises an emission unit receptacle 214 for containing the emission unit 212 therein. The emission unit 212 comprises an emission unit housing 216 within which is held a replaceable canister (not shown) in which the air-suspended light-obscuring matter is generated.

The holding of the emission unit 212 in the emission unit receiving portion 210 comprises the emission unit 212 being in a position in which the emission unit 212 has an electrical connection to control circuitry in the body 102 for receiving the delivery of electrical energy. The emission unit 212 is configured generate the air-suspended light-obscuring matter (e.g. smoke or fog) upon delivery of the energy.

In some embodiments, the control circuitry comprises a switch 230 (located behind a portion of the emission unit 212 as shown in FIG. 2) to identify when the emission unit 212 is being withdrawn from the emission unit receiving portion 210, as will be described in more detail below.

The emission unit 212 has an outlet (not shown) for emitting the matter and the outlet is positioned, when the emission unit 212 is held in the emission unit receiving portion 210, toward a bottom surface 114 of the device 100 to emit the matter from a bottom side 220 of the device 100.

The emission unit receiving portion 210 and the battery holder receiving portion 202 are adjacent to each other whereby neither one is on top of or above the other. Furthermore, the emission unit receiving portion 210 and the battery holder receiving portion 202 are each open at adjacent locations to a common bottom side 220 of the body for entry and removal of the emission unit 212 and the battery holder 204 in parallel directions (although the common side in other embodiments may be any side of the device). This allows for an unobstructed path for emission of the light-obscuring matter from the emission unit 212 and having the common side at the bottom, provides easy access to replace the batteries 206 while the device 100 is mounted on a wall. Furthermore, by having a removable battery holder 204, the batteries 206 are readily replaced with minimal fiddling. Similarly, the replacement of a canister in the emission unit 212 is easily facilitated while the device 100 is mounted on the wall.

The body 102 comprises a mechanical barrier 222. e.g. a wall, between the battery holder receiving portion 202 and the emission unit receiving portion 210 and between the battery holder receptacle 208 and the emission unit receptacle 214. The mechanical barrier 222 lies in a plane that is parallel to a longitudinal axis of the emission unit 212 when held in the emission unit receiving portion 210. The mechanical barrier 222 may serve to guide the emission unit 212 and/or battery holder 204 on entry into and/or removal from the emission unit receiving portion 210 and battery holder receiving portion 202, respectively. Advantageously, the mechanical barrier 222 is thermally insulative (e.g. by being comprised of a plastic or thermoplastic, for example PC-ABS) so that heat generated by either the batteries 206 or the emission unit 212 is not transferred through the mechanical barrier 222, or at least minimally. This ensures, for example, that heat resulting from the generation and/or emission of the air-suspended light-obscuring matter does not serve to heat the batteries 206, and therefore the risk of battery 206 malfunction or explosion due to heat is ameliorated.

FIG. 2 also shows a small portion of an interference member 300 which is described in more detail below.

In operation, the device 100 is configured to detect the motion or presence of a living entity within a detection area and, if the presence or motion of the living entity is detected, to emit the gathering of air-suspended light-obscuring matter, either automatically or upon receiving an emit instruction from a remote device that had been notified of the detected motion. However, additional or alternative different triggers could be used to trigger the release of the light-obscuring matter.

The canister in the emission unit 212 contains chemicals that react responsive to the supply of the energy to generate the light-obscuring matter, which is then emitted from the outlet. The reaction to generate the light-obscuring matter is generally exothermic. Although a specific example of an emission unit 212 is described above, other types of emission units for emitting light-obscuring matter could be used, e.g. a pressurized canister filled with the light-obscuring matter could be used instead. Furthermore, although in examples the light-obscuring matter is generated in-situ when needed for use by the emission unit 212, it will be appreciated that stored light-obscuring matter could be released instead.

FIG. 3 is an enlarged view of the bottom part of FIG. 2 with a portion of the battery holder 204 removed and two closest batteries 206, as viewed, removed. The interference member 300 is more clearly shown as comprising a projection or ledge extending normally from an upper end of an interference body 302. The interference body 302 is a generally rectangular plate that is held by the body 102 of the device 100 via a pivot mount 304 provided on the mechanical barrier 222 in the region of the battery holder receiving portion 202. The pivot mount 304 is located intermediate (approximately midway between) the upper end and a lower end of the interference body 302, the upper end being closer to the top end 112 of the device 100 and the lower end being closer to the bottom side 220 of the device 100, when the device 100 is mounted on a support wall.

The interference member 300 may be considered to comprise an upper surface 308 of the upper end of the interference body 302. The ledge of the interference member 300 is arranged to pass through a first slot in the mechanical barrier 222, with the interference body 302 remaining in the region of the battery holder receiving portion 202. The interference member 300 also comprises a foot 306 at an end of the ledge, substantially opposite to the upper end of the interference body 302. The foot 306 comprises a flange extending beyond a footprint of the ledge. The flange is configured to abut against a recessed portion of the mechanical barrier 222 when a free end of the foot 306 is flush with the mechanical barrier 222 on a side adjacent to the emission unit receiving portion 210.

The interference body 302 comprises an integrally-formed spring 310 extending from the interference body 302 between the pivot mount 304 and the interference member 300. In other embodiments, the spring 310 may comprise a discrete component, mechanically connected to the interference body 302. The spring 310 is configured to abut the mechanical barrier 222 to bias the interference member 300 to a blocking position in which the interference member 300 extends into a path of insertion and removal of the battery holder 204 to/from the battery holder receiving portion 202. The flange of the foot 306 may serve to limit an extent that the interference member 300 extends into the battery holder receiving portion 202 due to the force of the spring 310. An actuator 312 in the form of an integrally-formed transverse rib is provided towards the lower end of the interference body 302 and is configured to occupy a second slot in the mechanical barrier 222 when the interference member 300 is in its blocking position. In other embodiments, the actuator 312 may comprise a discrete component, mechanically connected to the interference body 302.

The interference member 300, the interference body 302 and the actuator 312 may, together, be considered as an interference component. As such, in the blocking position (as shown in FIG. 3), no part of the interference component extends into the emission unit receiving portion 210 from the first or second slots in the mechanical barrier 222.

As will be explained in more detail below, the interference member 300 is movable between (i) a blocking position that blocks receipt of the battery holder 204 into the battery-holder receiving portion 202 and (ii) a withdrawn position whereby the battery holder 204 is insertable into the battery-holder receiving portion 204. Furthermore, as shown in FIG. 3, when the battery-holder receiving portion 204 is in receipt of the battery holder 204, the interference member 300 is in the blocking position and blocks the removal of the battery holder 204.

Moreover, when the emission unit 212 (and in particular, the emission unit housing 216) is held in the emission unit receiving portion 210, as shown in FIG. 3, the interference member 300 is required to be in the blocking position. This is because, otherwise, the foot 306 would extend into the emission unit receiving portion 210 thereby blocking receipt of the emission unit 212.

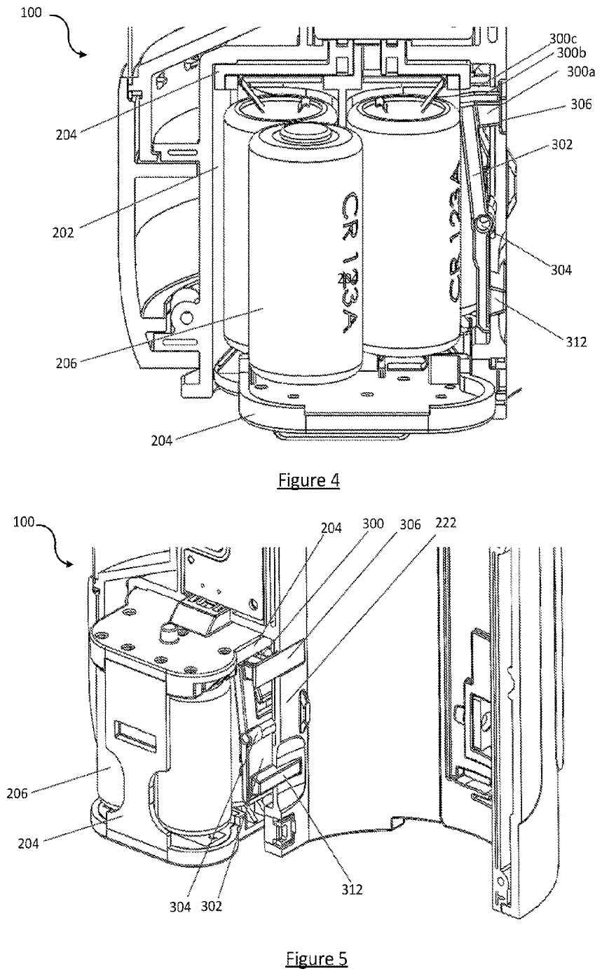

FIG. 4 shows an enlarged top perspective view of the battery-holder receiving portion 202 of FIG. 2 with a portion of the battery holder 204 removed and a single battery 206 removed. This view shows that the interference member 300 comprises a series of parallel ledges/projections 300a. 300b, 300c extending along a top portion of the interference body 302. In other embodiments, the interference member 300 may comprise a single ledge/projection.

FIG. 5 shows a rear perspective view of the battery holder 204 when received in the device 100 and with the emission unit 212 and a portion of the mechanical barrier 222 removed. This view shows that each of the ledges/projections of the interference member 300 are connected to a common foot 306. In other embodiments, each of the ledges/projections of the interference member 300 may be connected to separate foot portions.

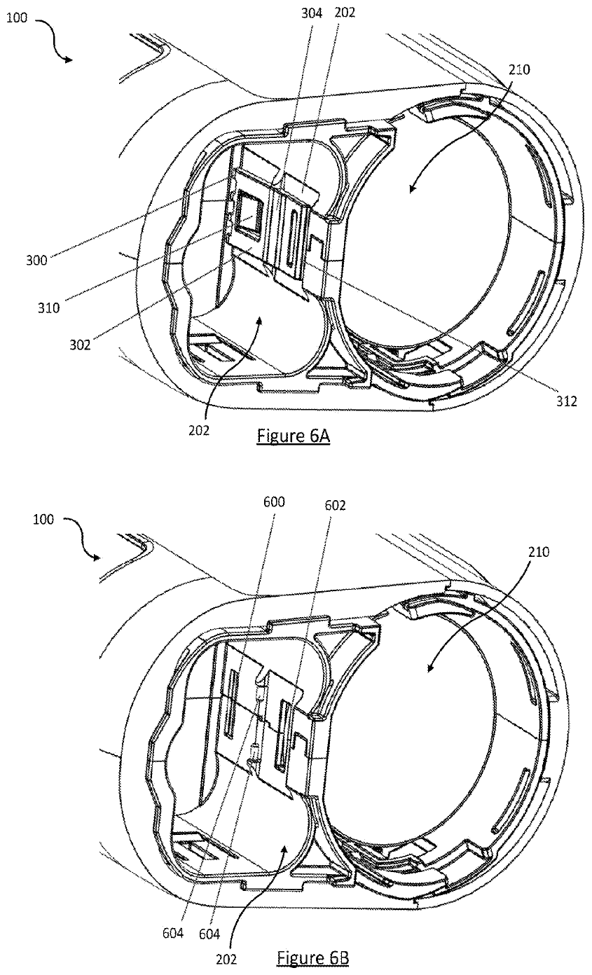

FIG. 6A shows a bottom perspective view of the battery-holder receiving portion 202 and emission unit receiving portion 210 without the battery holder 204 or emission unit 212, and showing the interference component there-between. As viewed, when looking at the mechanical barrier 222 from the battery-holder receiving portion 202, the interference body 302 is visible as well as portions of the interference member 300, spring 310, pivot mount 304 and actuator 312.

FIG. 6B shows a view similar to FIG. 6A but with the interference component removed. This view clearly shows the first slot 600 in which the interference member 300 occupies (when present) and the second slot 602 in which the actuator 312 occupies (when present). Two axially opposed and spaced apart spindles 604 are provided on the mechanical barrier 222, which are received in a hollow cylindrical portion of the pivot mount 304 to hold the interference component on the body 102.

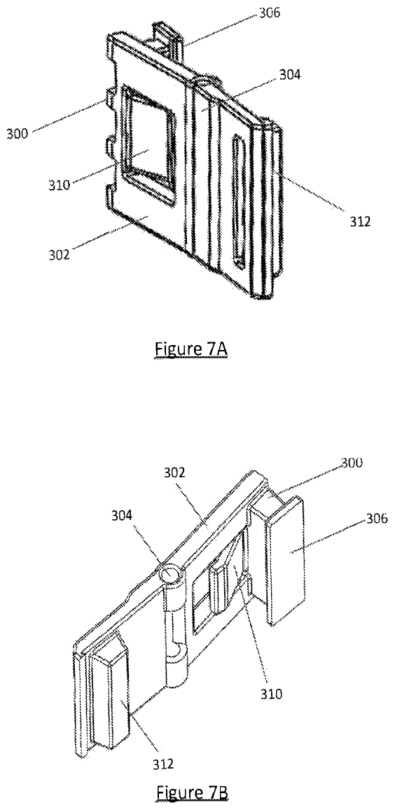

FIG. 7A shows a bottom perspective view of the interference component in isolation when viewed from the battery-holder receiving portion 202 and FIG. 7B shows a bottom perspective view of the interference component in isolation when viewed from an opposite side. It can be seen that the spring 310 is formed from a rectangular cut-out attached to the body along a top edge and bent in towards the mechanical barrier 222, when in use. The interference member 300 in this case includes four equi-distantly spaced ledges protruding from the top of the body to the common foot 306. The pivot mount 304 comprises a cylindrical hollow passage there-through for receipt of the spindles 604. The actuator 312 is a solid trapezoidal rib extending laterally across the bottom portion of the body 302 and having a slightly wider base than its free end.

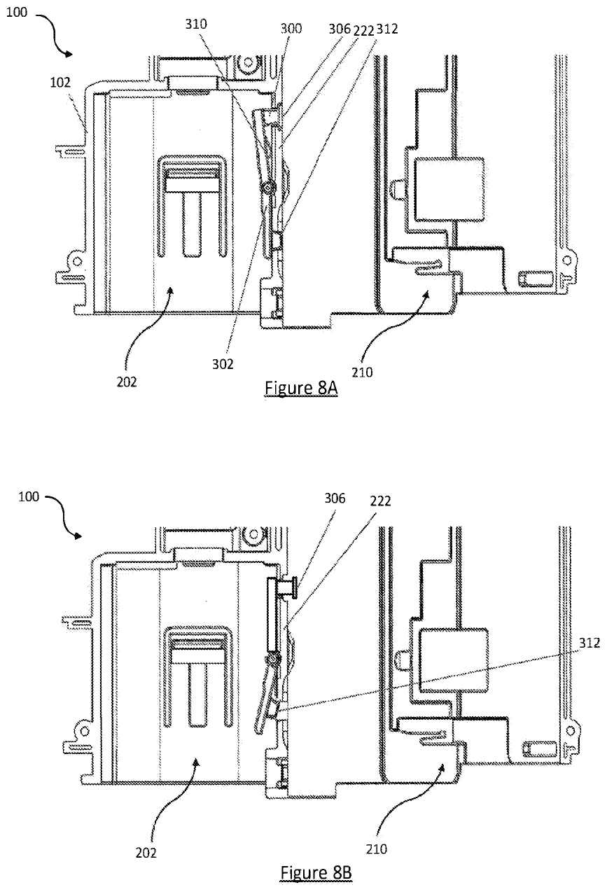

FIG. 8A shows an enlarged view of the bottom part of FIG. 2 with the battery holder 204 and emission unit 212 removed and the interference component in the blocking position. As illustrated, the spring 310 serves to bias the interference member 300 into the blocking position. As such, the interference member 300 extends into the battery-holder receiving portion 202 such that the during insertion of the battery holder 204 into the battery-holder receiving portion 202 a top portion of the battery holder 204 will abut the interference member 300. Continued insertion of the battery holder 204 will overcome the bias of the spring 310 and pivot the interference body 302 which will move the interference member 300 through the first slot 600 and the push the foot 306 into the emission unit receiving portion 210. This will allow the battery holder 204 to be fully inserted and received in the battery-holder receiving portion 202 to make an electrical connection with circuitry in the device body 102. It will be understood that it will only be possible for the interference member 300 to be moved out of the path of the battery holder 204 in the absence of the emission unit 212. This is because the presence of the emission unit 212 in the emission unit receiving portion 210 will prevent the foot 306 from moving into the emission unit receiving portion 210.

However, when the emission unit 212 is absent from the emission unit receiving portion 210, the interference member 300 may be moved into the withdrawn position by pressing the actuator 312, as shown in FIG. 8B. It will then be possible for the battery holder 204 to be removed from the battery-holder receiving portion 202.

Notably, in this embodiment, the actuator 312 is inaccessible when the emission unit 212 is held in the emission unit receiving portion 210. Further, even if the actuator 312 were accessible (e.g. were the emission unit shorter) pushing it would not result in movement of the interference member 300 into the withdrawn position because the presence of the emission unit 212 would prevent movement of the foot 306 into the emission unit receiving portion 210.

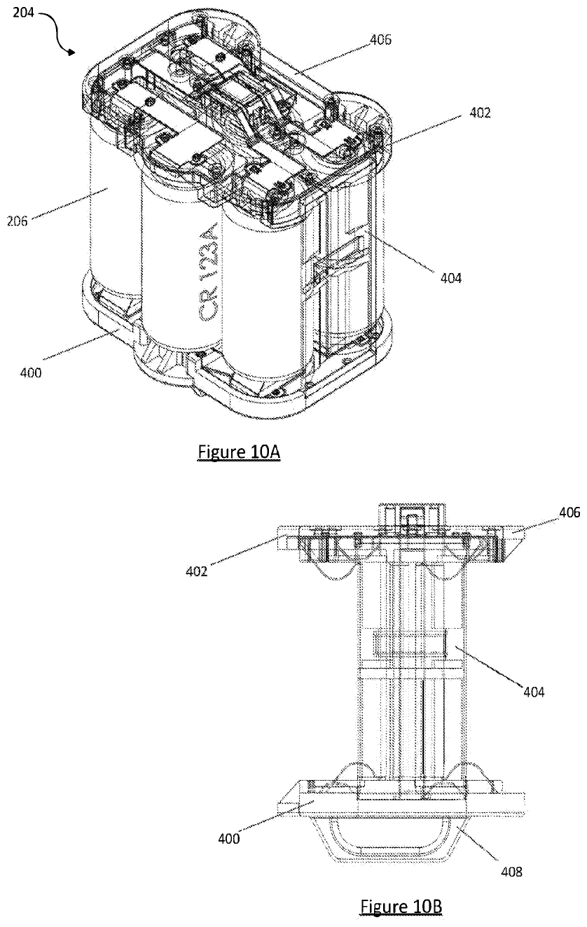

As described above, it is necessary for the battery holder 204 to be inserted into the battery-holder receiving portion 202 prior to the emission unit 212 being provided in the emission unit receiving portion 210. It is also necessary for the emission unit 212 to be removed from the emission unit receiving portion 210 before the battery holder 204 is removed from the battery-holder receiving portion 202. This is because the interference member 300 is configured to snap back into the blocking position, due to the spring 310, after a top ledge (406: FIG. 10B) of the battery holder 204 passes over the ledge(s) of the interference member 300 to place the battery holder 204 in its fully inserted position. In that fully inserted position, the battery holder 204 will be locked in the battery-holder receiving portion 202 by the interference member 300. An advantage of this arrangement is that it requires the batteries 206 to be electrically connected to the circuitry in the body 102 of the device 100 prior to, during and after receipt of the emission unit 212 and this ensures a stable electrical connection at all times when the emission unit 212 is present. As such, the risk of undesirable electrical charges which could inadvertently trigger unwanted emission from the emission unit 212 is mitigated.

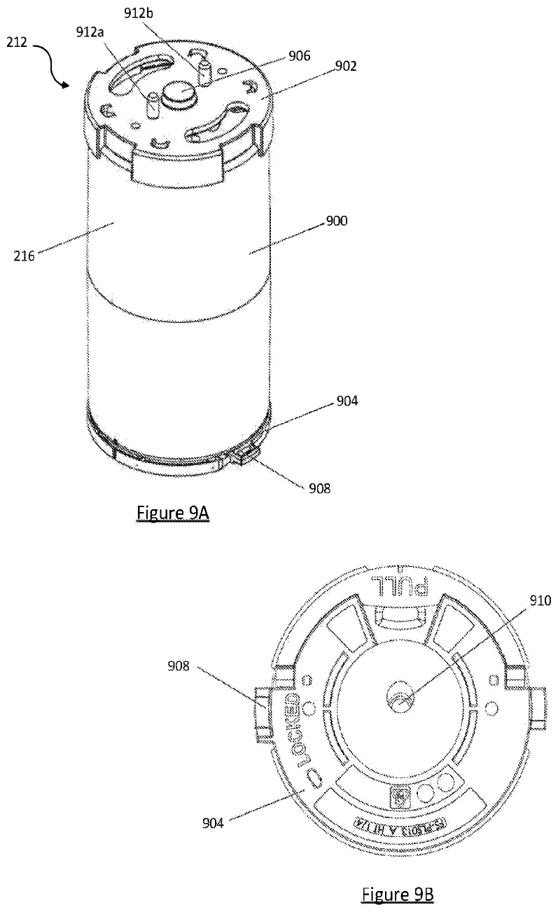

FIGS. 9A and 9B show, respectively, a top perspective view and bottom view of the emission unit 212 in FIG. 2. The emission unit housing 216 includes a canister containing tube 900, a top end cap 902 and a bottom end cap 904. The top end cap 902 includes a raised rigid surface 906 for pushing against and thereby interacting with the switch 230 that extends into the emission unit receiving portion 210 from an inner end of the emission unit receiving portion 210 as illustrated in FIG. 2. The switch 230 is a push switch that is configured to change its state when pressed by the rigid surface 906 on the inner end of the emission unit 212, when inserted and held in the emission unit receiving portion 210 whereby two electrical terminals 912a, 912b of the emission unit are electrically connected to circuitry in the body 102. The switch 230 is configured to have a first state when the emission unit 212 is held in the emission unit receiving portion 210 and a second state when the emission unit 212 is partially withdrawn from the emission unit receiving portion 210 and thereby electrically disconnected from the circuitry in the body 102. The device 100 is configured to transmit a notification to a remote device (e.g. a control device, server or monitoring station) when the switch 230 is changed to the second state.

For example, if the battery holder 204 is removed from the battery holder receiving portion 202, the device 100 will lose power. It is therefore advantageous to provide a warning that this may occur in advance of such power being lost. Advantageously, since it takes time for a person to be able to remove the emission unit 212 from the emission unit receiving portion 210 to thereby enable the withdrawal of the battery holder 204 from the battery holder receiving portion 202, and even partial withdrawal from the emission unit receiving portion 210 may trigger transmission of a notification, this provides such a warning. Furthermore, the time taken for a person to remove the emission unit 212 from the emission unit receiving portion 210 to enable removal of the battery holder 204 from the battery holder receiving portion 202 may be longer than the time taken to reach said partial withdrawal, and may provide sufficient time for the device 100 to connect to a cellular network (which may take as long as 5 seconds, for example) and transmit the notification prior to the power being lost.

The bottom end cap 904 is provided with an outlet 910 for emission of the light-obscuring matter and has two opposed radial wings 908. The emission unit 212 is held in place in the emission unit receiving portion 210 by rotation of the bottom end cap 904 with respect to the canister containing tube 900 so as to engage the wings 908 with recesses in the emission unit receiving portion 210. Such rotation effectively locks the emission unit 212 in position. The bottom end cap 904 may be rotated in the opposite direction to release the wings 908 from the recesses, and thereby enable the emission unit 212 to move downward, as illustrated, out of the emission unit receiving portion 210.

FIGS. 10A and 10B show, respectively, a top perspective view and a side view of the battery holder 204 partially shown in FIG. 2. In FIG. 10A six batteries 206 are provided in the battery holder 204 whereas in FIG. 10B, no batteries are shown. It will be understood that the number and type of batteries 206 required by the device 100 may vary depending on power requirements and different applications.

The battery holder 204 comprises a base 400, a top 402, two opposed side panels 404 and two open sides for insertion of the batteries 206. The top 402 includes a ledge 406 for abutting with the interference member 300 as described previously (i.e. either to block insertion or removal of the battery holder 204 into or out of the battery-holder receiving portion 202 when the emission unit 212 is installed). The base 400 includes a handle 408 for pulling the battery holder 204 out of the battery-holder receiving portion 202. Electrical contacts for connecting the batteries 206 to control circuitry when the battery holder 204 is received in the battery-holder receiving portion 202 are also provided.

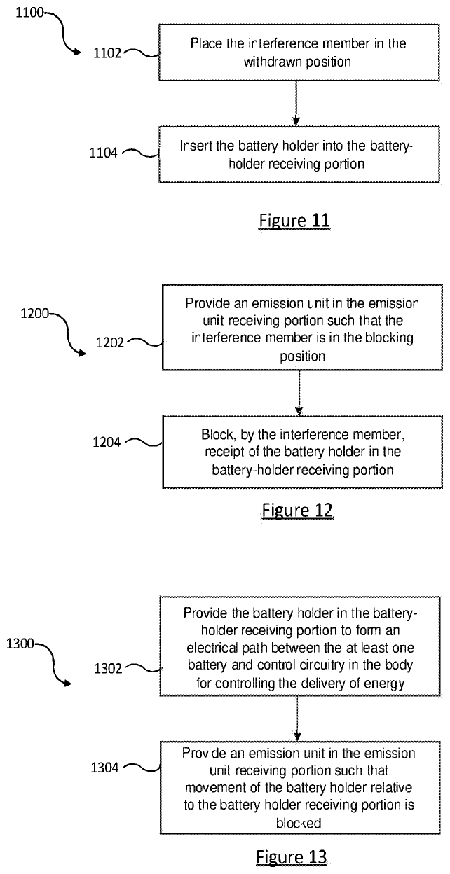

FIG. 11 is a flow chart of a method 1100 of installing at least one battery 206 in a visibility-impairing security device 100 according to an embodiment of the disclosure. The method 1100 comprises a first step 1102 of placing the interference member 300 in the withdrawn position and a second step 1104 of inserting the battery holder 204 into the battery-holder receiving portion 202. In some embodiments, for example as in the embodiment described herein, the step of inserting the battery holder 204 into the battery-holder receiving portion 202 is sufficient to push the interference member 300 into the withdrawn position (against the bias of the spring 310), as long as the emission unit 212 is not present to prevent the interference member 300 from adopting the withdrawn position, thereby rendering step 1102, as a separate step, redundant. As will be appreciated, the method 1100 would comprise a preliminary step of removing the emission unit 212 from the emission unit receiving portion 210 should the emission unit 212 be already loaded into the body 102.

FIG. 12 is a flow chart of a method 1200 of preventing installation of at least one battery 206 in a visibility-impairing security device 100 according to an embodiment of the disclosure. The method 1200 comprises a first step 1202 of providing an emission unit 212 in an emission unit receiving portion 210 such that the interference member 300 is in the blocking position. A second step 1204 comprises blocking, by the interference member 300, receipt of the battery holder in the battery-holder receiving portion 202.

It will be understood that installation of the battery holder 204 will be permitted if the emission unit 212 is removed from the emission unit receiving portion 210 and either the actuator 312 is pressed to move the interference member 300 into the withdrawn position or the battery holder 204 is inserted into the battery-holder receiving portion 202 with enough force to overcome the bias of the spring 310 and push the interference member 300 into the withdrawn position.

FIG. 13 is a flow chart of a method 1300 of preventing removal of at least one battery 206 in a visibility-impairing security device 100 according to an embodiment of the disclosure. The method 1300 comprises a preliminary step 1302 of providing the battery holder 204 in the battery-holder receiving portion 202 to form an electrical path between the at least one battery 206 and control circuitry in the body 102 for controlling the delivery of energy. A removal prevention step 1304 comprises providing an emission unit 212 in the emission unit receiving portion 210 such that movement of the battery holder 204 relative to the battery holder receiving portion 202 is blocked.

It will be understood that removal of the battery holder 204 will be permitted if the emission unit 212 is removed from the emission unit receiving portion 210 and the actuator 312 pressed to move the interference member 300 into the withdrawn position.

Aspects of the disclosure relate to improved security devices 100 in which light-obscuring matter may be output as a deterrent to ward off an intruder and wherein the unintended emission of such matter is minimised because the batteries 206 must always be installed in the device 100 prior to installation of the emission unit 212 (as otherwise the insertion of the batteries 206 is blocked). This feature ensures that the emission unit 212 is only present when there is likely to be a stable electrical connection between the batteries 206 and the device circuitry. More specifically, the configuration of the device 100 requires that the batteries 206 be loaded before the emission unit 212 to mitigate the risk of transient electrical states triggering an unintended emission of matter.

It will be understood that in the various embodiments described, there is some kind of security related event (e.g. a detected motion, or an instruction from a device that operates within a security system) which triggers directly or indirectly the output of the light-obscuring matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Furthermore, features described in relation to one embodiment may be mixed and matched with features from one or more other embodiments, within the scope of the claims.

1. A visibility-impairing security device for producing a gathering of air-suspended light-obscuring matter to obscure vision, the device comprising:
an insertable battery holder for holding at least one battery; and
a body comprising:
a battery-holder receiving portion for receiving therein the battery holder; and
an emission unit receiving portion for holding an emission unit for emitting the matter in response to a delivery of energy derived from the at least one battery; and
an interference member held by the body and movable between (i) a blocking position that blocks receipt of the battery holder into the battery-holder receiving portion and (ii) a withdrawn position whereby the battery holder is insertable into the battery-holder receiving portion;
wherein when the emission unit is held in the emission unit receiving portion the interference member is in the blocking position.

2. The device of claim 1, wherein receipt of the battery holder into the battery-holder receiving portion forms an electrical path, and wherein the emission unit generates the air-suspended light-obscuring matter upon delivery of the energy.

3. The device of claim 2, wherein breaking the electrical path by relative movement of the battery holder with respect to the body requires the interference member to be moved out of the blocking position.

4. The device of claim 1, wherein, when the emission unit is held in the emission unit receiving portion, the emission unit blocks the interference member from being in the withdrawn position.

5. The device of claim 1, wherein holding of the emission unit in the emission unit receiving portion comprises the emission unit being in a position in which the emission unit has an electrical connection for receiving the delivery of energy.

6. The device of claim 1, wherein absence of the emission unit from the emission unit receiving portion enables the interference member to be in the withdrawn position.

7. The device of claim 1, wherein, when the emission unit is absent from the emission unit receiving portion, the interference member is moveable into the withdrawn position by inserting the battery holder into the battery holder receiving portion towards a position in which an electrical path exists between the at least one battery and control circuitry in the body for controlling the delivery of energy.

8. The device of claim 7, wherein, when the battery holder is in said position in which an electrical path exists between the at least one battery and control circuitry in the body for controlling the delivery of energy, the interference member is returned by a biasing force to the blocking position to block removal of the battery holder from the battery holder receiving portion.

9. The device of claim 1, wherein, when the emission unit is absent from the emission unit receiving portion, the interference member is moveable into the withdrawn position by pressing an actuator and wherein the actuator is inaccessible when the emission unit is held in the emission unit receiving portion.

10. The device of claim 1, wherein, when the emission unit is absent from the emission unit receiving portion, the interference member is moveable into the withdrawn position by pressing an actuator, and wherein the actuator and the interference member are on opposite ends of a component that rocks about a pivot axis within the body and intermediate the opposite ends.

11. (canceled)

12. (canceled)

13. The device of claim 1, wherein the interference member is biased towards the blocking position.

14. (canceled)

15. (canceled)

16. The device of claim 1, wherein entry and/or removal of the emission unit and the battery holder are in parallel directions.

17. The device of claim 1, wherein the emission unit receiving portion and the battery holder receiving portion are adjacent to each other and wherein the emission unit receiving portion and the battery holder receiving portion each open at adjacent locations to a common side of the body.

18-28. (canceled)

29. The device of claim 1, wherein the body comprises a mechanical barrier between the battery holder receiving portion and the emission unit receiving portion, and wherein the mechanical barrier is thermally insulative.

30. (canceled)

31. (canceled)

32. A method of installing at least one battery in a visibility-impairing security device of claim 1, the method comprising:
placing the interference member in the withdrawn position; and
inserting the battery holder into the battery-holder receiving portion.

33-41. (canceled)

42. A kit for producing a gathering of air-suspended light-obscuring matter to obscure vision, the kit comprising:
a visibility-impairing security device accordingly to claim 1; and
an emission unit for emitting the matter in response to a delivery of energy derived from the at least one battery.

43. The kit of claim 42, wherein the insertable battery holder is provided preinstalled in the body of the device or separate from the body of the device.
